(19) United States
(12) Patent Application Publication
(10) Pub. No.: US 2014/0041691 A1
(43) Pub. Date: Feb. 13, 2014

(54) MOBILE WASHING APPARATUS

(71) Applicant: Wade Glasscock, Saraland, AL (US)

(72) Inventor: Wade Glasscock, Saraland, AL (US)

(21) Appl. No.: 13/570,321

(22) Filed: Aug. 9, 2012

(51) Int. Cl. B08B 3/02

(52) U.S. Cl. 134/34; 134/198

(57) ABSTRACT

A mobile washing apparatus is disclosed. The mobile washing apparatus can include a mobile chassis having a plurality of wheels, a first spray head assembly, and a first adjustable support structure. The first spray head assembly may have a first spray head having a top plate and a side skirt. The top plate and side skirt can together define an interior space. A first rotating sprayer wand may be located within the interior space of the first spray head. The first adjustable support structure supports the first spray head assembly from the mobile chassis. The first adjustable support structure can be configured such that the first spray head assembly is positionable in a horizontal direction and positionable in a vertical direction. The first spray head also defines a face angle and the first adjustable support structure is configured such that the face angle of the first spray head is adjustable.

### BACKGROUND

Traffic barriers, such as concrete traffic barriers, are commonly located along roads and highways to separate lanes of traffic. In many applications, such barriers are permanently constructed or are placed into long-term service. Over time, traffic activity can cause concrete barriers to become heavily saturated and coated with contaminants that can cause the concrete to deteriorate. In order to prevent deterioration, concrete barriers can be cleaned, such as by pressure washing with a sprayer wand. However, many cleaning processes utilized to date are time consuming and often cause long disruptions in traffic flow and a corresponding increase in risk exposure for cleaning personnel. Improvements are desired.

### SUMMARY

A mobile washing apparatus is disclosed. The mobile washing apparatus can have a mobile chassis including a plurality of wheels to easily move the mobile chassis along a floor or ground. The mobile chassis may have a first spray head assembly that can include a first spray head with a top plate and a side skirt that together define an interior space. The first spray head can also include a first rotating sprayer wand located within the interior space of the first spray head. A first adjustable support structure can be used to support the first spray head assembly from the mobile chassis. The first adjustable support structure may be configured such that the first spray head assembly is positionable in a horizontal direction and positionable in a vertical direction. Additional spray head assemblies and adjustable support structures are also disclosed.

### DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a front view of a traffic barrier washer having features that are examples of aspects in accordance with the principles of the present disclosure.

FIG. 2 is a side view of the traffic barrier washer shown in FIG. 1.

FIG. 3 is a top view of the traffic barrier washer shown in FIG. 1.

FIG. 4 is a cross-sectional top view of the traffic barrier washer shown in FIG. 1, taken along the line 4-4.

FIG. 5 is a bottom view of a spray head assembly usable with the traffic barrier washer shown in FIG. 1.

FIG. 6 is a top view of the spray head assembly shown in FIG. 5.

FIG. 7 is an illustration of a fluid communication manifold.

FIG. 8 is perspective view of the spray head assembly of FIG. 1.

FIG. 9 is a partial enlarged view of FIG. 8.

FIG. 10 is a perspective view of a portion of FIG. 1 showing a wheel assembly.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

A mobile washing apparatus 100 is presented for cleaning contaminated surfaces. The surfaces to be cleaned may include walls, buildings, angular surfaces, and the like. One type of surface to be cleaned is a roadway barrier 200. Roadway barriers 200 can include a variety of types, including, but not limited to, Jersey barriers, constant slope barriers, step barriers, and F-shape barriers. The roadway barriers 200 may be painted or non-painted. Roadway barriers 200 can be made of different material. One popular material used to make roadway barriers 200 is concrete. Although a concrete barrier is shown as an example of a roadway barrier 200 to describe a mobile washing apparatus 100 in accordance with the principles of the disclosure, it is understood that other materials and material combinations, such as plastic barriers filled with water, can be used.

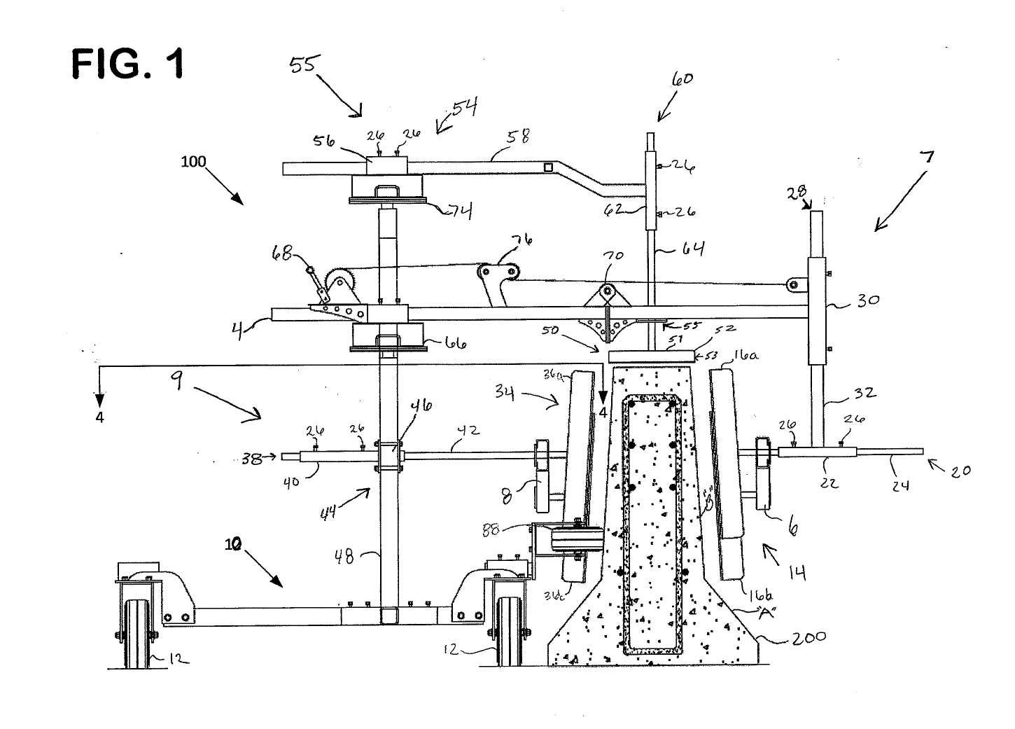

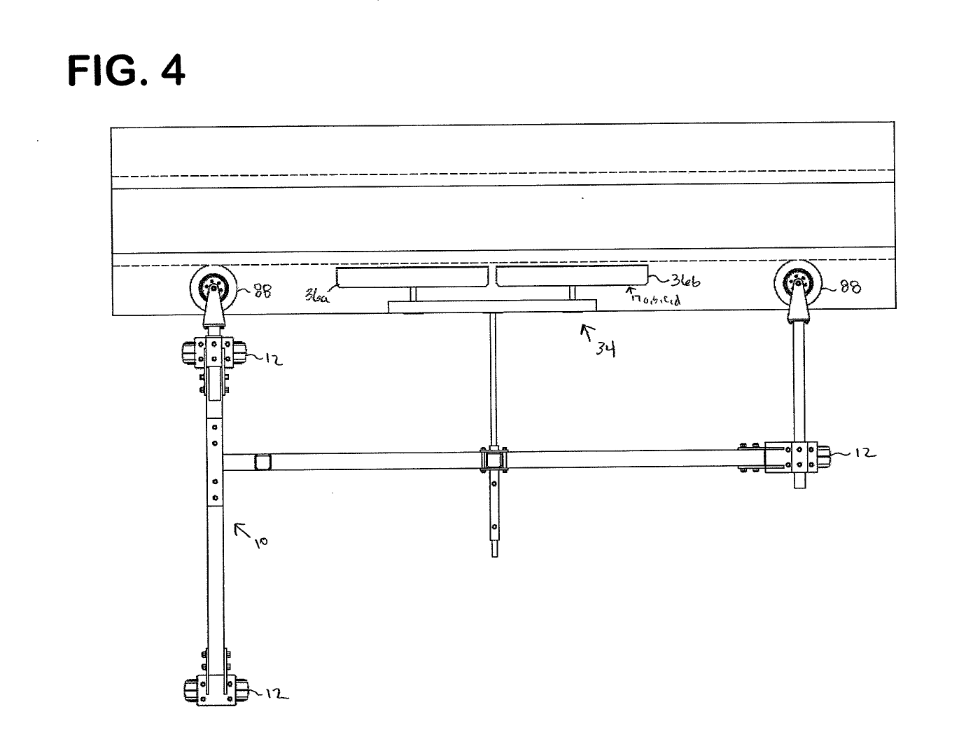

Referring now to FIGS. 1-6, a mobile washing apparatus 100 is shown. The mobile washing apparatus 100 can include a mobile chassis 10 with a plurality of wheels, multiple spray head assemblies, and adjustable support structures. The plurality of wheels may be configured to move the mobile washing apparatus 100 across a floor or ground. As shown, the mobile washing apparatus 100 has three wheels 12. It is understood that more or fewer wheels 12 may be used according to the principles disclosed, for example four wheels. The wheels 12 can be assembled to a wheel assembly 602 that may be mounted on the chassis 10 with a fastener, such as, but not limited to, bolts 610. As shown, the wheels 12 are Pneumatic type tires. The wheels 12 may also be solid tires that have advantageous wear properties in this particular application over Pneumatic tires. One example is a Bush Hog type tire. This type of tire is made by several manufacturers, such as, Weifang Yijia Imp. & Exp. Co., Ltd., located in China. It is to be understood that other types of tires can be used according to the present disclosure.

As shown, the mobile washing apparatus 100 has three spray head assemblies. It is to be understood that fewer or more spray head assemblies may be used without departing from the principles disclosed herein. As shown, the mobile washing apparatus 100 has three adjustable support structures, each of which supports a spray head assembly from the mobile chassis 10. The adjustable support structures may be arranged and configured to position the spray head assemblies in a horizontal direction and a vertical direction. In one embodiment, the adjustable support structures include a vertical directing mechanism and a horizontal directing mechanism. The mobile washing apparatus 100 is described in more detail below.

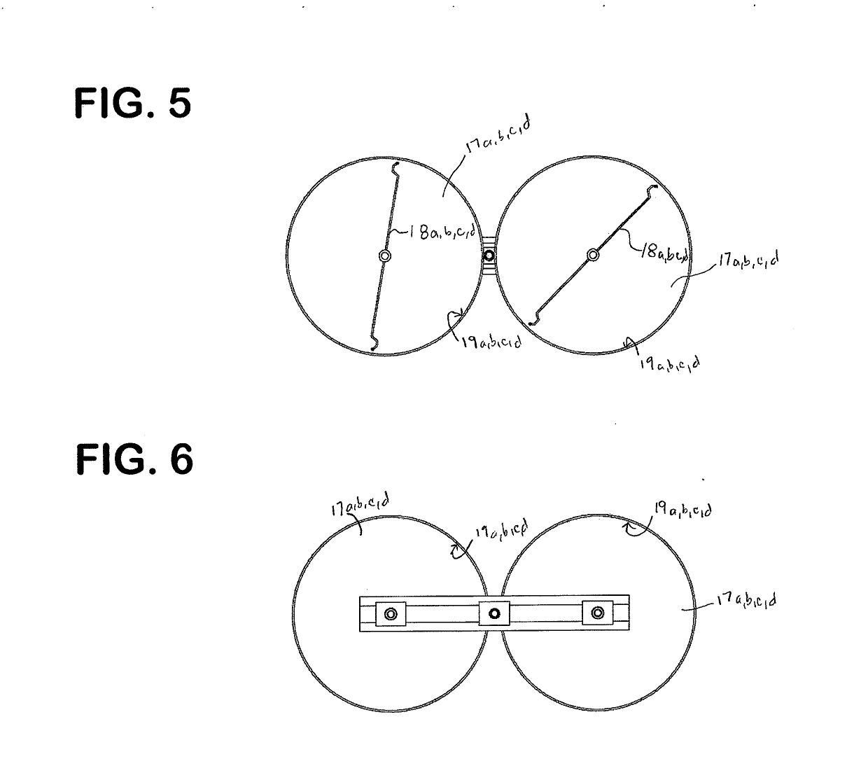

In one aspect, a first spray head assembly 14 can be mounted to the mobile chassis 10. The first spray head assembly 14 may include a first spray head 16a and a second spray head 16b configured adjacent to each other and supported by a first rotatable bar 6. Although two spray heads are shown, the configuration may have more or less spray heads. The first and second spray heads 16a, 16b can each include a top plate 17a, b, and a side skirt 19a, b that together define an interior space, which may help to keep the spray contained and directed towards the surface to be cleaned. The first and second spray heads 16a, 16b can each include first and second rotating sprayer wands 18a, b within the interior space of the first and second spray heads 16a, 16b, as shown in FIG. 5. The first and second rotating sprayer wands 18a, b may include a spray nozzle at each end. Any type of spray nozzle may be utilized. In one embodiment, the spray nozzles are separated by about 25 inches, and can be angled at about 15 degrees. The spray nozzles can be configured to deliver about 4 gallons per minute of water to the surface to be cleaned. Pressurized water delivered to the spray nozzles can cause the first and second rotating sprayer wands 18a, b to spin and develop a rotating action.

Referring again to FIG. 1, a first adjustable support structure 7 can be used to support the first spray head assembly 14 from the mobile chassis 10. The first adjustable support structure 7 may include a first horizontal directing mechanism 20 and a first vertical directing mechanism 28. As shown, the first and second spray heads 16a, 16b can be positioned as desired using the first horizontal directing mechanism 20 of the first adjustable support structure 7 and the first vertical directing mechanism 28 of the first adjustable support structure 7.

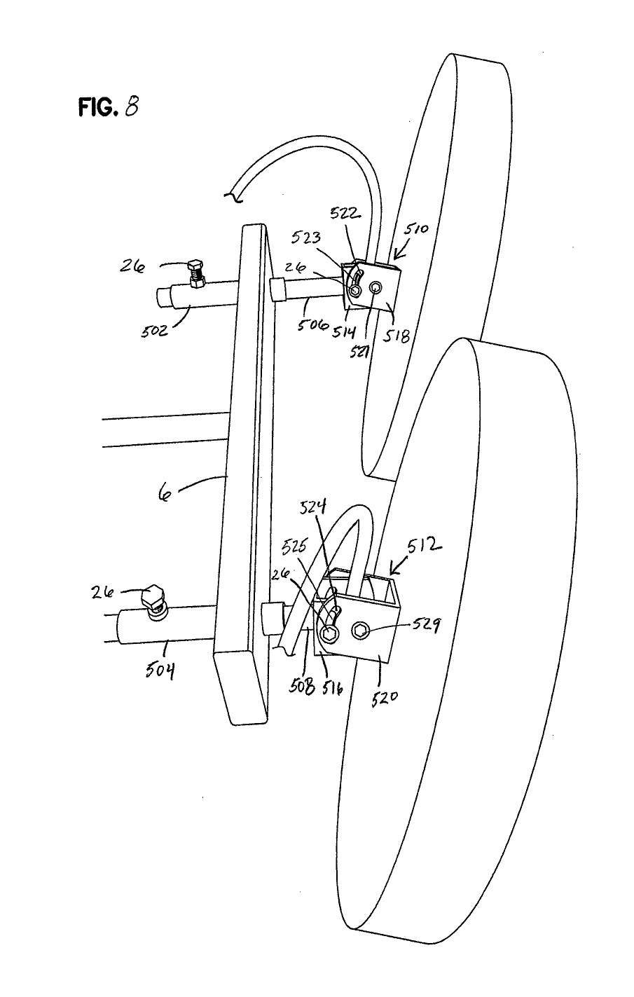

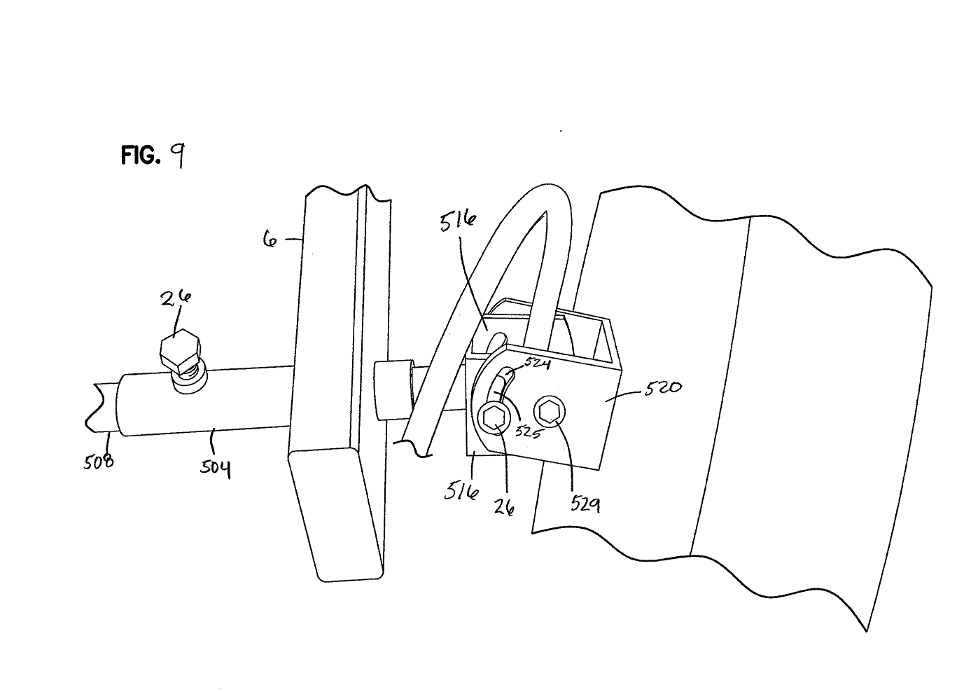

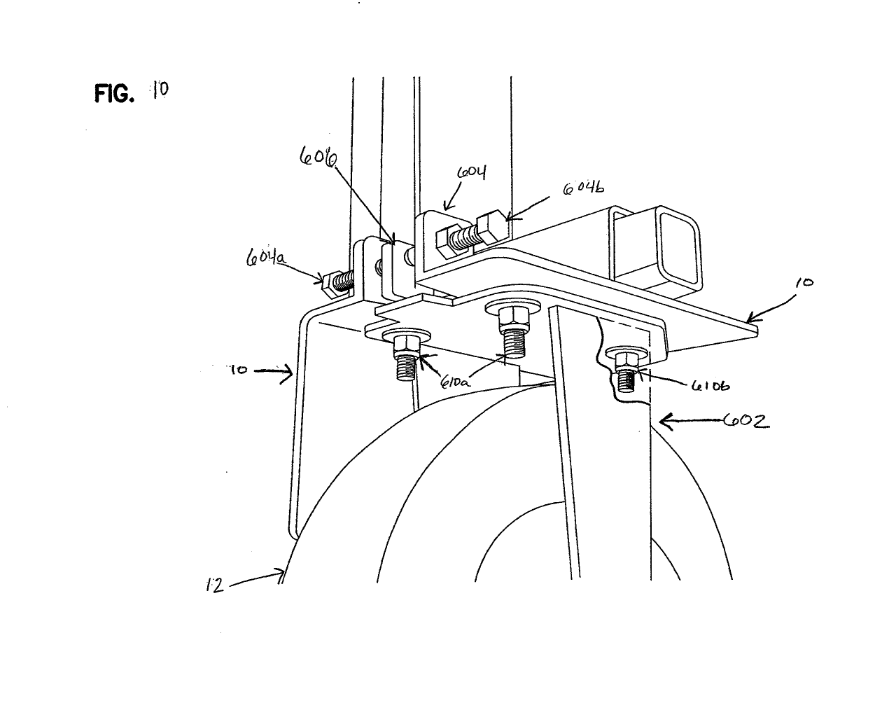

The first adjustable support structure 7 may also be configured such that the first and second spray heads 16a, 16b are independently adjustable in a horizontal direction and/or a vertical direction. A configuration in which independent horizontal adjustment of the spray heads using inner and outer rods is provided is presented at FIGS. 8-9. As shown, a first and second outer rod 502, 504 can be mounted to the first rotatable bar 6. The first and second outer rods 502, 504 are configured to receive a first and second inner rod 506, 508, respectively. Each of the inner rods 506, 508 is arranged and configured to slide in and out of the first and second outer rods 502, 504. This allows for independent horizontal positioning of the first and second spray heads 16a, 16b in the horizontal direction. In order to secure the position of the inner rods 506, 508, a fastener, such as a set screw 26, may be provided in the outer rods 502, 504. Other types of fasteners or fastening systems may be used to secure the position of the inner rods 502, 504 with respect to the outer rods 506, 508.

The first support structure can also be configured to allow for the first and second spray heads 16a, 16b to have independently adjustable face angles. In one embodiment, the first and second inner rods 506, 508 supporting the spray heads 16a, 16b can be mounted to a first and second pivot connection 510, 512, respectively. The pivot connections 510, 512 allow for the spray heads 16a, 16b to be rotatable with respect to the inner rods 506, 508. Many configurations of pivot connections are possible. In the embodiment shown, the first and second pivot connections 510, 512 can include a first and second frame 514, 516, that may be mounted on the first and second inner rods 506, 508, and a first and second bracket 518, 520, that can be mounted on a side of the first and second spray heads 16a, 16b. The first and second frames 514, 516 and the first and second brackets 518, 520 may each define slot openings 522, 523, 524 and 525. As shown, the slot openings 522, 523, 524 and 525 are on both sides of each of the first and second frames 514, 516 and the first and second brackets 518, 520. However, it is possible to provide only a single slot opening in either the frames 514, 516 or the brackets 518, 520 while still providing for a pivoting function. As shown, the first and second brackets 518, 520 are configured to be positioned over the first and second frames 514, 516 and connected at the slot openings 522, 523, 524 and 525 using a fastener, such as set screw 26. As shown, the first and second brackets 518, 520 and the first and second frames 514, 516 are U-shaped and are connected together such that the brackets 518, 520 extend over the frames 514, 516. The arrangement and shape of the brackets 518, 520 and frames 514, 516 can vary according to principles of the disclosure.

The position of the face angle can be fixed in a desired position by fasteners, such as set screws 26, by securing the first and second brackets 518, 520 to the first and second frames 514, 516. As shown, the first and second brackets 518, 520 can be attached to the first and second frames 514, 516 and positioned along the overlapping slot openings 522, 523, 524 and 525. The first and second pivot connections 510, 512 can each pivot about a pivot point thereby providing for an adjustable spray head face angle. In one embodiment, a pivot point is provided by a fixed set screw 527, 529 in the first and second pivot connections 510, 512. As shown, the fixed set screws 527, 529 connect the first and second brackets 518, 520 to the first and second frames 514, 516. In one embodiment, the face angle of the first and second spray heads 16a, 16b, as determined by the placement and length of the slot openings, can have an adjustable range between a generally vertical position to a generally horizontal position. In one embodiment, and as shown, the face angle of the spray heads 16a, 16b is adjustable from about vertical to about a 45 degree angle with respect to the ground. Accordingly, the face angle of one (or both) of the spray heads 16a, 16b can be adjusted to face a bottom pitch of a roadway barrier 200 while the other spray head can be adjusted to face the main portion of the roadway barrier 200, or other surface. Because the face angle adjustment of each spray head is independent of the other, the washing apparatus can be configured to simultaneously clean surfaces having compound angles, such as the bottom pitch and the main surface of a roadway barrier. FIG. 1 shows an example of a bottom pitch as surface A of the roadway barrier 200 while the main surface area, which is at an angle with respect to surface A, is identified as surface B.

The first horizontal directing mechanism 20 may include a first horizontal adjustment sleeve 22 and a first horizontal support rod 24. The first horizontal support rod 24 can be arranged and configured to slide in and out of the first horizontal adjustment sleeve 22 and rotate therein to position the first spray head assembly 14 as desired. The first vertical directing mechanism 28 may include a first vertical adjustment sleeve 30 and a first vertical support rod 32. The first vertical support rod 32 can be arranged and configured to slide in and out of the first vertical adjustment sleeve 30 and rotate therein to position the first spray head assembly 14 as desired. It is to be understood that the first vertical and first horizontal directing mechanisms 20, 28 can be configured in a variety of ways without departing from the concepts presented herein. The first adjustable support structure 7 enables the first spray head assembly 14 to be positioned as desired along a surface to be cleaned, i.e. a facing side of the roadway barrier 200.

In another aspect, the first and second spray heads 16a, 16b may define a face angle such that the first adjustable support structure 7 can be configured to adjust the face angle of the first and second spray heads 16a, 16b relative to a surface to be cleaned, i.e. roadway barrier 200. The first adjustable support structure 7 can also be configured to position the first spray head assembly 14 in a horizontal direction and in a vertical direction. In rotating the first rotatable bar 6, the first and second spray heads 16a, 16b may be configured substantially vertical to one another, substantially horizontal to one another, or at an angle relative to one another. The position of the first and second spray heads 16a, 16b can be configured such that the surface to be cleaned is contacted by both spray heads 16a, 16b in an overlapping arrangement. This configuration allows the spray heads 16a, 16b to be adjusted to have a cleaning height that matches the height of the barrier 200 such that cleaning can be accomplished in a single pass. Additionally, where contamination is especially heavy, the arrangement allows for each spray head 16a, 16b to be arranged such that the contaminated surface cleaned twice in a single pass of the washing apparatus 100, such as would be the case when the spray heads 16a, 16b are placed in a horizontal orientation.

The positions of the first horizontal directing mechanism 20 and the first vertical directing mechanism 28 can be fixed by a fastener, such as, but not limited to, a set screw 26. As shown, two set screws 26 are used, but any number can be included. It is understood that other fasteners may be used, for example, a threaded fastener, a thumbscrew, a pin, a bolt, a dowel, a latch, a collet and the like.

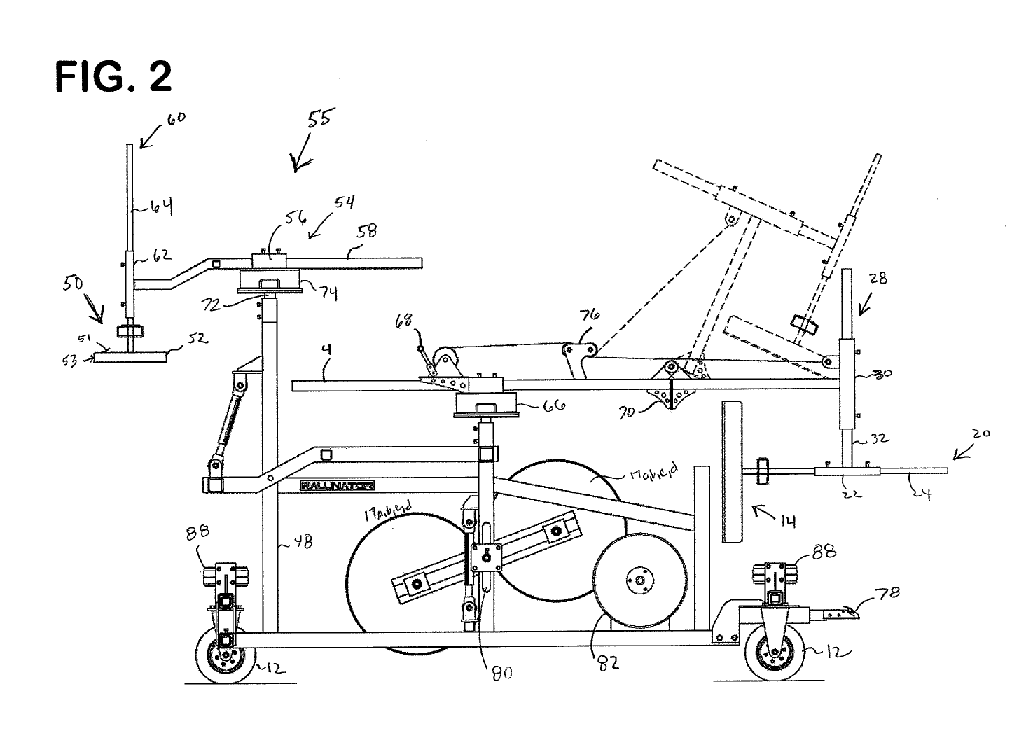

In another aspect, the first adjustable support structure may further include a lift arm 4, as shown in FIGS. 1 and 2. The lift arm 4 can be configured with a pulley device 76 that may include a crank lever 68 to lift the first spray head assembly 14 around a pivot axis 70. The lift arm 4 provides for the height of the first spray head assembly 14 to be adjusted and can further provide a configuration for storing the mobile washing apparatus 100. The first spray head assembly 14 can move about a first swivel head 66 to swing in a horizontal direction.

In another aspect, a second spray head assembly 34 can be mounted to the mobile chassis 10. The second spray head assembly 34 may include a third spray head 36a and a fourth spray head 36b configured adjacent to each other and supported by a second rotatable bar 8. Although two spray heads are shown, any number of spray heads can be used according to the principles disclosed. The third and fourth spray heads 36a, 36b can each include a top plate 17c, d and a side skirt 19c, d that together define an interior space, which may help to keep the spray contained. The third and fourth spray heads 36a, 36b can each include third and fourth second rotating sprayer wands 18c, d located within the interior space of the third and fourth spray heads 36a, 36b, as shown in FIG. 5. The third and fourth rotating sprayer wands 18c, d may include a spray nozzle at each end. Any type of spray nozzle may be utilized. In one embodiment, the spray nozzles are separated by about 25 inches, and can be angled at about 15 degrees. The spray nozzles can be configured to deliver about 4 gallons per minute of water to the surface to be cleaned. Pressurized water delivered to the spray nozzles can cause the third and fourth rotating sprayer wands 18c, d to spin and develop a rotating action.

A second adjustable support structure 9 can be used to support the second spray head assembly 34 from the mobile chassis 10. The second adjustable support structure 9 may include a second horizontal directing mechanism 38 and a second vertical directing mechanism 44. As shown, the third and fourth spray heads 36a, 36b can be positioned as desired using the second horizontal directing mechanism 38 of the second adjustable support structure 9 and the second vertical directing mechanism 44 of the second adjustable support structure 9.

The second support structure 9 may also be provided with a pivot mechanism and independent horizontal and/or vertical positioning of the spray heads 36a, 36b similar to those described for the first adjustable support structure 7. Accordingly, many of the concepts and features for the second support structure 9 are similar to the first adjustable support structure 7 shown in FIGS. 8-9. As such, the description for the pivot mechanism and the independent horizontal and/or vertical movement of the first adjustable support structure 7 is hereby incorporated by reference in their entirety for the second adjustable support structure 9.

The second horizontal directing mechanism 38 may include a second horizontal adjustment sleeve 40 and a second horizontal support rod 42. The second horizontal support rod 42 can be arranged and configured to slide in and out of the second horizontal adjustment sleeve 40 and rotate therein to position the second spray head assembly 34 as desired. The second vertical directing mechanism 44 may include a second vertical adjustment sleeve 46 and a second vertical support rod 48. The vertical support rod 48 may define a vertical adjustment slot 80 therein to receive the second vertical adjustment sleeve 46. The second vertical adjustment sleeve 46 can be arranged and configured to slide up and down within the vertical adjustment slot 80 of the second vertical support rod 48 to position the second spray head assembly 34 as desired. Other mechanism can be used to move the spray heads 36a, 36b according to the principles disclosed. The second spray head assembly 34 can be arranged and configured opposite the first spray head assembly 14 to face a surface to be cleaned opposite therefrom, i.e. roadway barrier 200.

In another aspect, the third and fourth spray heads 36a, 36b may define a face angle such that the second adjustable support structure 9 can be configured to adjust the face angle of the third and fourth spray heads 36a, 36b relative to a surface to be cleaned, i.e. roadway barrier 200. The second adjustable support structure 9 can be configured to position the second spray head assembly 34 in a horizontal direction and in a vertical direction. In rotating the second rotatable bar 8, the third and fourth spray heads 36a, 36b may be configured substantially vertical to one another, substantially horizontal to one another, or at an angle relative to one another. The position of the third and fourth spray heads 36a, 36b can be configured such that the surface to be cleaned is contacted by both spray heads 36a, 36b in an overlapping arrangement.

The positions of the second horizontal directing mechanism 38 and the second vertical directing mechanism 44 can be fixed by a fastener, such as, but not limited to, a set screw 26. As shown, two set screws 26 are used, but any number may be included. Other fastening devices and arrangements can be used in accordance with the principles disclosed.

Referring to FIG. 2, a third spray head assembly 50 is mounted to the mobile chassis 10. The third spray head assembly 50 may include a fifth spray head 52 that can be configured upon a second swivel head 74 located on a telescoping arm 72 to move horizontally. Although one spray head is shown, any number of spray heads can be used according to the principles disclosed. The fifth spray head 52 can include a top plate 51 and a side skirt 53 that together define an interior space that may help to keep the spray contained. The fifth spray head 52 may include a fifth rotating sprayer wand located within the interior space of the fifth spray head 52. The fifth rotating sprayer wand may include a spray nozzle at each end. Any type of spray nozzle may be utilized. In one embodiment, the spray nozzles are separated by about 25 inches, and can be angled at about 15 degrees. The spray nozzles can be configured to deliver about 4 gallons per minute of water to the surface to be cleaned. Pressurized water delivered to the spray nozzles can cause the fifth rotating sprayer wand to spin and develop a rotating action.

A third adjustable support structure 55 can be used to support the fifth spray head assembly 50 from the chassis 10. The third adjustable support structure 55 may include a third horizontal directing mechanism 54 and a third vertical directing mechanism 60. As shown, the fifth spray head 52 can be positioned as desired using the third horizontal directing mechanism 54 of the third adjustable support structure 55 and the third vertical directing mechanism 60 of the third adjustable support structure 55. The third adjustable support structure 55 may also be configured similarly to the first and second support structure 7, 9 such that the fifth spray head 52 is pivotable like the first, second, third or fourth spray heads. Accordingly, the features of the pivoting mechanism described above for the first support structure 7 are hereby incorporated by reference in their entirety to the third adjustable support structure 55.

The third horizontal directing mechanism 54 may include a third horizontal adjustment sleeve 56 and a third horizontal support rod 58. The third horizontal support rod 58 can be arranged and configured to slide in and out of the third horizontal adjustment sleeve 56 to position the third spray head assembly 50 as desired. The third vertical directing mechanism 60 may include a third vertical adjustment sleeve 62 and a third vertical support rod 64. The third vertical support rod 64 can be arranged and configured to slide in and out of the third vertical adjustment sleeve 62 to position the third spray head assembly 50 as desired. Other mechanism can be used to move the fifth spray head 52 according to the principles disclosed.

In one aspect, the fifth spray head 52 may define a face angle such that the third adjustable support structure 55 can be configured to adjust the face angle of the firth spray head 52 relative to a surface to be cleaned, i.e. roadway barrier 200. The third adjustable support structure 55 can be configured to position the third spray head assembly 50 in a horizontal direction and in a vertical direction. The positions of the third horizontal directing mechanism 54 and the third vertical directing mechanism 60 can be fixed by a fastener, such as, but not limited to, a set screw 26. As shown, two set screws 26 are used, but any number may be included. Other fastening devices and arrangements can be used in accordance with the principles disclosed.

In another aspect, guide wheels 88 can be mounted on the mobile chassis 10 and configured to ensure consistent clearance between the first and second spray heads 16a, 16b and a surface to cleaned, i.e. roadway barrier 200 and the third and fourth spray heads 36a, 36b and a surface to be cleaned, i.e. roadway barrier 200. The clearance between the spray heads and the surface to be cleaned is about 1-2 inches due to the guide wheels. It is to be understood that the clearance can vary according to the principles of the disclosure. As shown, there are two guide wheels 88 mounted to the chassis 10, although more or fewer wheels 88 could be used. The guide wheels 88 can be oriented horizontally to contact a wall or surface to be cleaned. The guide wheels 88 can also provide proper tracking along a surface to be cleaned to keep the mobile washing apparatus 100 aligned while in motion. The third spray head assembly 50 can be arranged and configured to clean a top surface to be cleaned, i.e. top of the roadway barrier 200.

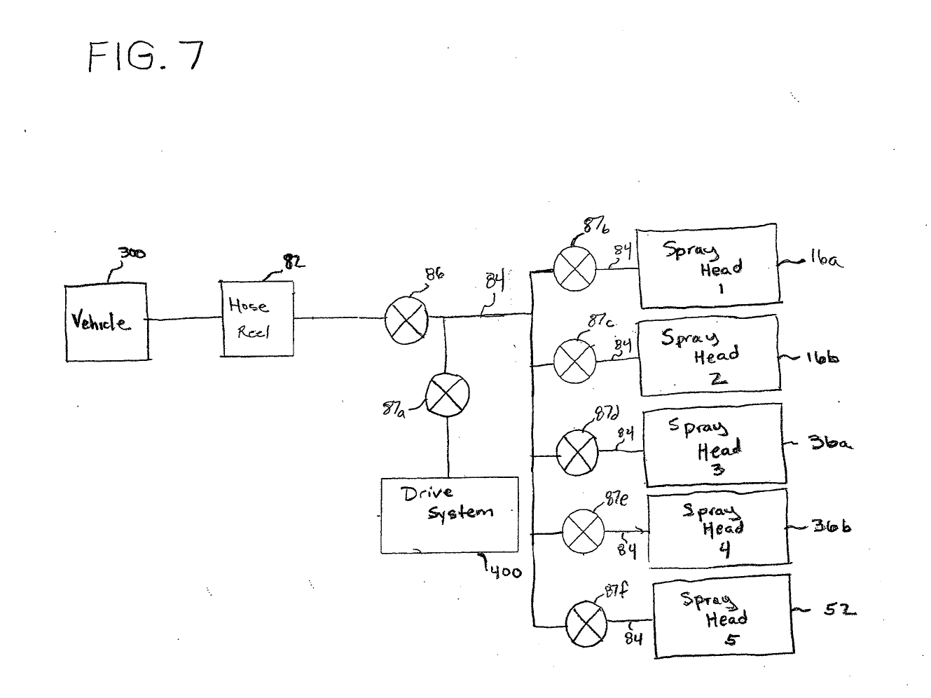

FIG. 2 illustrates a hitch 78 that can be provided on the mobile chassis 10 to allow the barrier washing apparatus 200 to be pulled by a motor vehicle and will be further described with reference to the system components of FIG. 7.

Referring now to FIG. 7, the mobile washing apparatus 100 is schematically shown as being configured with a shut off valve 86 to deliver or distribute water to each spray head and rotating sprayer wand 18 through pressurized water hoses 84. Isolation valves 87 a-f are used to control fluid flow to activate a desired spray head. The isolation valves 87 a-f can be manually or automatically operated. Also, the isolation valves 87 a-f can be operated such that spray heads on one side of the mobile washing apparatus 100 are used or such that spray heads on both sides are used. For example, valves 87 c-d can be open to operate spray heads 16a, 16b, while valves 87d-f are shut off.

Referring now to FIG. 10, the wheels 12 on the chassis 10 can be configured to be set at an angle with respect to the surface to be cleaned to provide an anti-thrust action for keeping the mobile washing apparatus 100 properly aligned with respect to the surface to be cleaned. In some applications, especially where the mobile washing apparatus 100 is set up to cleaning only one side of a roadway barrier, setting the wheels at an angle is beneficial because the pressurized water discharging from a spray head can produce a sufficient thrust force to move the mobile chassis 10 away from the roadway barrier. By positioning the wheels 12 at an angle towards the surface to be cleaned, the mobile chassis 10 can counteract the thrust force as the mobile chassis 10 is moving along in a cleaning direction. Thus, the wheels 12 can provide the necessary lateral force to maintain proper engagement between the guide wheels 88 and the surface to be cleaned to ensure sufficient alignment of the mobile washing apparatus 100.

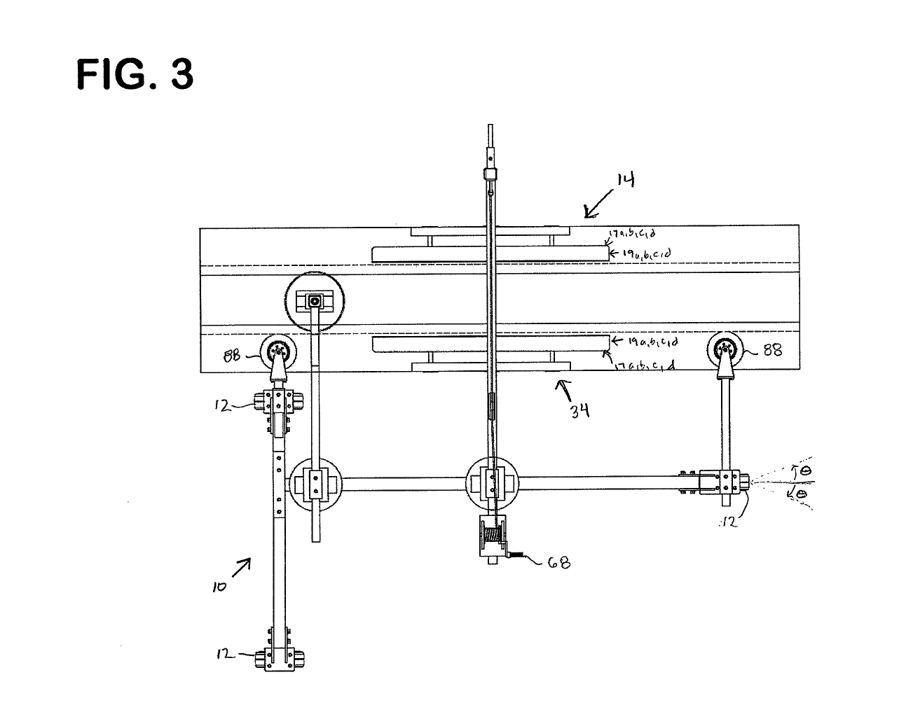

As shown, the wheel assembly 602 includes three fasteners 610 in the form of two front bolts 610a and one rear bolt 610b, which can be used to mount the wheel assembly 602 to the chassis 10. Other fastener arrangements are possible. In one example, the two front bolts 610a connecting the wheel assembly 602 to the chassis 10 can be positioned in either radial slots or enlarged holes in order to adjust a steering angle θ (shown in FIG. 3) of the wheels 12. The wheel assembly 602 can pivot around the rear set screw 26b while adjusting the steering angle θ. To adjust the steering angle θ, the front bolts 610a may be loosened to allow a vertical member 606 to be offset to either the right or left by an adjustment screw member 604. At least one of the left or right adjustment screw members 604a, 604b are turned to offset the vertical member 606 to turn the wheel in the toe-in position or the toe-out position at a desired angle. In one example, the wheels 12 may have an adjustable steering angle θ that provides for a toe-in adjustment from approximately zero to 7 degrees and a toe-out adjustment of approximately zero to 7 degrees.

It is to be understood that the steering angle θ can vary according to the principles disclosed. Furthermore, it is to be understood that the angle adjustment is adjustable such that the mobile chassis 10 may be placed on either side of a surface to be cleaned while still obtaining a toe-in configuration. This feature is beneficial because the mobile washing apparatus 100 may be placed and operated on either side of a roadway barrier or other surface to be cleaned. All the wheels 12 can be positioned to have the same steering angle θ or alternatively all the wheels 12 can have different steering angles θ. For example, each of the wheels 12 are preferably adjusted to have a toe-in steering angle of about 1½-2 degrees such that the wheels guide the chassis 10 towards the surface to be cleaned when moving the chassis 10 in the cleaning direction. Once the desired steering angle θ is obtained, the two front bolts 610a can be securely fastened to the chassis 10 and the adjustment screw members 604a, 604b can be likewise tightened.

The mobile chassis 10 can be pushed or pulled manually or by a vehicle, or the mobile chassis 10 can be self-propelled through the use of a drive system 400. The drive system 400 can be an electric motor, a hydraulic motor, or an engine. As shown, drive system 400 is a hydraulic motor powered by the pressurized water source that powers the spray heads. The mobile chassis 10 can also be attached to a vehicle 300, such as, but not limited to, a water tank truck, by the hitch 78 to have supply of pressurized water delivered to the mobile washing apparatus 100. The pressurized water delivered can be delivered at about 0-50 gallons per minute and can have a pressure of about 0-40,000 PSI. The mobile chassis 10 can also be attached to a vehicle 300 configured to pull the mobile washing apparatus 100 by the pressurized water hose 84.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A mobile washing apparatus comprising:
(a) a mobile chassis having a plurality of wheels;
(b) a first spray head assembly including:
i. a first spray head having a top plate and a side skirt that together define an interior space;
ii. a first rotating sprayer wand located within the interior space of first spray head; and
(c) a first adjustable support structure that supports the first spray head assembly from the mobile chassis; the first adjustable support structure being configured such that the first spray head assembly is positionable in a horizontal direction and positionable in a vertical direction.

2. The mobile washing apparatus of claim 1, wherein at least one of the plurality of wheels has an adjustable steering angle.

3. The mobile washing apparatus of claim 1, wherein the first spray head defines a face angle and wherein the first adjustable support structure is configured such that the face angle of the first spray head is adjustable.

4. The mobile washing apparatus of claim 3, wherein the first spray head is pivotally mounted to a pivot connection.

5. The mobile washing apparatus of claim 1, wherein the first spray head assembly further comprises:
(a) a second spray head having a top plate and a side skirt that together define an interior space;
(b) a second rotating sprayer wand located within the interior space of first spray head; and
(c) wherein the first and second spray heads are supported by a first rotatable bar.

6. The mobile washing apparatus of claim 5, wherein the second spray head defines a face angle and wherein the first adjustable support structure is configured such that the face angle of the first and second spray heads is independently adjustable.

7. The mobile washing apparatus of claim 5, wherein the first and second spray heads are each independently positionable in the horizontal direction.

8. The mobile washing apparatus of claim 1, wherein the first adjustable support structure is movable and rotatable about a first swivel head.

9. The mobile washing apparatus of claim 5, wherein the mobile washing apparatus further comprises:
(a) a second spray head assembly including:
i. a third spray head having a top plate and a side skirt that together define an interior space;
ii. a third rotating sprayer wand located within the interior space of third spray head;
iii. a fourth spray head having a top plate and a side skirt that together define an interior space;
iv. a fourth rotating sprayer wand located within the interior space of fourth spray head;
v. the third and fourth spray heads being supported by a second rotatable bar; and
(b) a second adjustable support structure that supports the second spray head assembly from the mobile chassis; the second adjustable support structure being configured such that the second spray head assembly is positionable in a horizontal direction and positionable in a vertical direction.

10. The mobile washing apparatus of claim 9, wherein the third and fourth spray heads each define a face angle and wherein the second adjustable support structure is configured such that the face angle of the third and fourth spray heads is independently adjustable.

11. The mobile washing apparatus of claim 10, wherein the mobile washing apparatus further comprises:
(a) a third spray head assembly including:
i. a fifth spray head having a top plate and a side skirt that together define an interior space;
ii. a fifth rotating sprayer wand located within the interior space of fifth spray head; and
(b) a third adjustable support structure that supports the third spray head assembly from the mobile chassis; the third adjustable support structure being configured such that the third spray head assembly is positionable in a horizontal direction and positionable in a vertical direction.

12. The mobile washing apparatus of claim 11, wherein:
(a) the first adjustable support structure is configured such that the first spray head assembly can be positioned to generally face a first surface to be cleaned; and
(b) the second support structure is configured such that the second spray head assembly can be positioned to generally face a second surface to be cleaned, the first and second surfaces to be cleaned facing in generally opposite directions.

13. The mobile washing apparatus of claim 12, wherein:
(a) the third adjustable support structure is configured such that the third spray head assembly can be positioned to generally face a third surface to be cleaned that is generally orthogonal to the first and second surfaces to be cleaned.

14. The mobile washing apparatus of claim 11, further comprising a manifold providing fluid communication between a pressurized water source and the first, second, third, fourth, and fifth sprayer wands.

15. The mobile washing apparatus of claim 11, wherein the third adjustable support structure is movable and rotatable about a second swivel head.

16. The mobile washing apparatus of claim 1, further comprising at least one guide wheel operably mounted to the mobile chassis, the guide wheel being configured to engage with a first surface to be cleaned to maintain alignment between the mobile chassis and the first surface to be cleaned.

17. The mobile washing apparatus of claim 1, further comprising a drive mechanism to propel the mobile chassis.

18. The mobile washing apparatus of claim 17, wherein the drive mechanism is a hydraulic motor.

19. The mobile washing apparatus of claim 1, wherein the first adjustable support structure comprises:
(a) a first horizontal directing mechanism;
(b) wherein the first horizontal directing mechanism is connected to the first spray head, and the first horizontal directing mechanism includes:
i. a first horizontal adjustment sleeve;
ii. a first horizontal support rod;
iii. wherein the first horizontal support rod is movably mounted within the first horizontal adjustment sleeve and movable therein between a disengaged position and an engaged position;
iv. wherein in the engaged position, a fastener fixes the first horizontal support rod relative to the first horizontal adjustment sleeve, and in the disengaged position, the first horizontal support rod is free to move relative to the first horizontal adjustment sleeve; and
v. wherein the first horizontal adjustment sleeve and the first horizontal support rod are arranged and configured for positioning the first spray head.

20. The mobile washing apparatus of claim 19, wherein the first adjustable support structure further comprises:
(a) a first vertical directing mechanism;
(b) wherein the first vertical directing mechanism is connected to the first spray head, and the first vertical directing mechanism includes:
i. a first vertical adjustment sleeve;
ii. a first vertical support rod;
iii. wherein the first vertical support rod is movably mounted within the first vertical adjustment sleeve, and movable therein between a disengaged position and an engaged position;
iv. wherein in the engaged position, a fastener fixes the first vertical support rod relative to the first vertical adjustment sleeve, and in the disengaged position, the first vertical support rod is free to move relative to the first vertical adjustment sleeve; and
v. wherein the first vertical adjustment sleeve and the first horizontal support rod are arranged and configured for positioning the first spray head.

21. The mobile washing apparatus of claim 1, further comprising guide wheels to provide a minimum distance of about 1 to 2 inches between a spray head and a surface to be cleaned.

22. A method of cleaning a surface, the method comprising:
(a) positioning at least one spray head adjacent to a surface to be cleaned, including sliding a support rod of a directing mechanism relative to an adjustment sleeve to determine position of the at least one spray head relative to the surface to be cleaned;
(b) adjusting an adjustable support structure in a horizontal direction and a vertical direction to position a face angle of the at least one spray head assembly adjacent to the surface to be cleaned;
(c) activating a pressurized water source to the at least one spray head and a rotatable sprayer wand inside the at least one spray head; and
(d) moving a mobile washing apparatus having the at least one spray head mounted thereon along a floor or ground.
